(19) United States
(12) Patent Application Publication
(10) Pub. No.: US 2003/0161630 A1
(43) Pub. Date: Aug. 28, 2003

(54) System and method of setting thresholds for optical performance parameters

(76) Inventors: Harish Jayaram, Plano, TX (US); Cengiz Aydin, Plano, TX (US); Curtis Brownmiller, Richardson, TX (US); Michael U. Bencheck, Denison, TX (US)

Correspondence Address: WORLDCOM, INC., Technology Law Department, 1133 19th Street, N.W., Washington, DC, 20036, US

(21) Appl. No.: 10/268,766

(22) Filed: Oct. 11, 2002

Related U.S. Application Data
(60) Provisional application No. 60/328,908, filed on Oct. 12, 2001.
(60) Provisional application No. 60/328,953, filed on Oct. 12, 2001.

(51) Int. Cl. H04B 10/08

(52) U.S. Cl. 398/9; 398/26; 398/28; 398/38; 398/25

(57) ABSTRACT

A method, and optical network management system is provided for monitoring an optical transmission system, including assigning a plurality of threshold values corresponding to a performance parameter associated with the optical transmission system. The method, and optical network management system further perform the step of identifying degradation of the optical transmission system based on which of the threshold values being exceeded.

### CROSS REFERENCE TO RELATED CASES

The present invention claims the benefit of priority under 35 U.S.C. §119(e) to commonly-owned, commonly-assigned, U.S. Provisional Patent Application No. 60/328,908 of Jayaram et al., entitled “OPTICAL PERFORMANCE MONITORING,” filed on Oct. 12, 2001, and U.S. Provisional Patent Application No. 60/328,953 of Jayaram et al., entitled “OPTICAL SYSTEMS AND METHODS,” filed on Oct. 12, 2001, the entire contents of both of which are incorporated by reference herein.

### FIELD OF THE INVENTION

The present invention generally relates to communications systems, and more particularly, to setting thresholds for optical performance monitoring of an optical network.

### BACKGROUND OF THE INVENTION

The rapid proliferation of optical networking has brought many benefits to customers of telecommunications network service providers, including high bandwidth, new and enhanced services, reduced prices, and potential for future service expansion. Unfortunately, the technical ability to monitor and analyze optical network traffic has lagged behind such benefits. The problem is exacerbated with use of extended reach optical network elements in attempts to achieve all-optical telecommunications networks, and the associated elimination of electrical monitoring points used to perform trouble isolation of a transmission network in current infrastructures.

For example, conventional optical transmission networks (e.g., Synchronous Optical NETwork (SONET), Synchronous Digital Hierarchy (SDH), etc.) have optical to electrical (o/e) conversions at transmission sites, which are border points between line, section, and path entities that define a physical layer of the transmission systems. Transmission performance is measured at the electrical layer with use of electrical performance parameters. However, although such electrical performance parameters can indicate if errors have been received, they do not supply enough information to assess the actual cause of the electrical performance degradation.

Some optical networks do not have optical-to-electrical (o/e) and back to optical (o/e/o) conversions within network boundaries. For example, within boundaries of a Dense Wavelength Division Multiplexing (DWDM) network, there may be very few o/e/o conversions for testing and monitoring purposes. In fact, these conversions are kept to a minimum, because insertion of o/e/o devices is relatively costly. In addition, introducing many o/e/o points in an all-optical network would make the network behave more like a SONET or SDH network, and thus, eliminate the relative advantages of less equipment, less space requirements, etc., that are gained from an all-optical network. However, with the elimination of these electrical monitoring points, the ability to isolate the cause of degradations and failures in the transmission network is further reduced. Further, if the above problems were addressed by manual testing and isolation methods, this would result in labor-intensive and time-consuming operations, increasing the optical facility downtime, and resulting in degraded reliability.

### SUMMARY OF THE INVENTION

Therefore, there is a need for detecting degradations and failures in an optical network and for isolating the cause of the degradations and/or failures, via an automated process, with reduced relative cost, with greater accuracy of error detection, and while minimizing the number of electrical monitoring points.

The above and other needs are addressed by embodiments of the present invention, which provide an improved method and system for monitoring an optical transmission system including a plurality of optical network elements. In optical transmission systems, degradation of optical performance parameters (e.g., optical power (OP), optical signal-to-noise ratio (OSNR), wavelength drift, etc.) of the optical network elements affects error performance parameters in the electrical domain. According to one embodiment, a threshold setting process automatically assigns degradation intensity threshold values (Q₁, Q₂, . . . Qₙ) used to identify which optical performance parameters are degraded. According to another embodiment, a data collection process collects optical performance data for a finite period of time in receive and transmit directions for optical network elements between associated electrical monitoring points, and based on degree of intensity of degradation of the threshold values. The data collection process checks for electrical domain error rate degradation between the electrical monitoring points to initiate the data collection. According to further embodiment, a data analysis process analyzes the collected optical performance data to determine if a single degraded optical performance parameter and/or a combination of degraded optical performance parameters is causing the electrical error performance degradation. The data analysis process then determines the particular optical network elements, fiber facility segments, etc., that are causing the optical parameters' degradation, leading to the error performance degradation in the electrical domain. By employing the non-intrusive monitoring techniques of the embodiments of the present invention to identify optical performance degradation, collect optical performance data associated with the optical performance degradation, and analyze the collected data for identifying root cause(s) of performance degradation in the electrical domain, advantageously, the problems associated with manual testing and conventional isolation methods are avoided.

Accordingly, in one aspect of an embodiment of the present invention, a method of monitoring an optical transmission system is disclosed. The method includes assigning a plurality of threshold values corresponding to a performance parameter associated with the optical transmission system. The method further includes identifying degradation of the optical transmission system based on which of the threshold values being exceeded.

According to another aspect of an embodiment of the present invention, an optical network management system is disclosed. The system includes means for assigning a plurality of threshold values corresponding to a performance parameter associated with an optical transmission system. The system further includes means for identifying degradation of the optical transmission system based on which of the threshold values being exceeded.

In yet another aspect of an embodiment of the present invention, a computer-readable medium carrying one or more sequences of one or more instructions for monitoring an optical transmission system is disclosed. The one or more sequences of one or more instructions include instructions which, when executed by one or more processors, cause the one or more processors to perform the step of assigning a plurality of threshold values corresponding to a performance parameter associated with the optical transmission system. Another step includes identifying degradation of the optical transmission system based on which of the threshold values being exceeded.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of an exemplary optical transmission system that can employ setting of thresholds for optical performance monitoring, according to an embodiment of the present invention;

FIG. 2A is a block diagram of a Dense Wavelength Division Multiplexing (DWDM) device, supporting optical-to-electrical-to-optical (o/e/o) conversion, which can be employed in the system of FIG. 1;

FIG. 2B is a block diagram of an all-optical (o/o/o) Dense Wavelength Division Multiplexing (DWDM) device, which can be employed in the system of FIG. 1;

FIG. 3 is a block diagram of an optical amplifier, which can be employed in the system of FIG. 1;

FIGS. 4A-4C are a flow chart of a process for setting thresholds for optical performance monitoring of the optical transmission system of FIG. 1, according to an embodiment of the present invention; and

FIG. 5 is an exemplary computer system that can be programmed to perform one or more of the processes, in accordance with various embodiments of the present invention.

### DESCRIPTION OF THE PREFERRED EMBODIMENTS

A method and system for setting of thresholds for optical performance monitoring of an optical network are described. In the following description, for purposes of explanation, numerous specific details are set forth in order to provide a thorough understanding of the present invention. It is apparent to one skilled in the art, however, that the present invention can be practiced without these specific details or with an equivalent arrangement. In some instances, well-known structures and devices are shown in block diagram form in order to avoid unnecessarily obscuring the present invention.

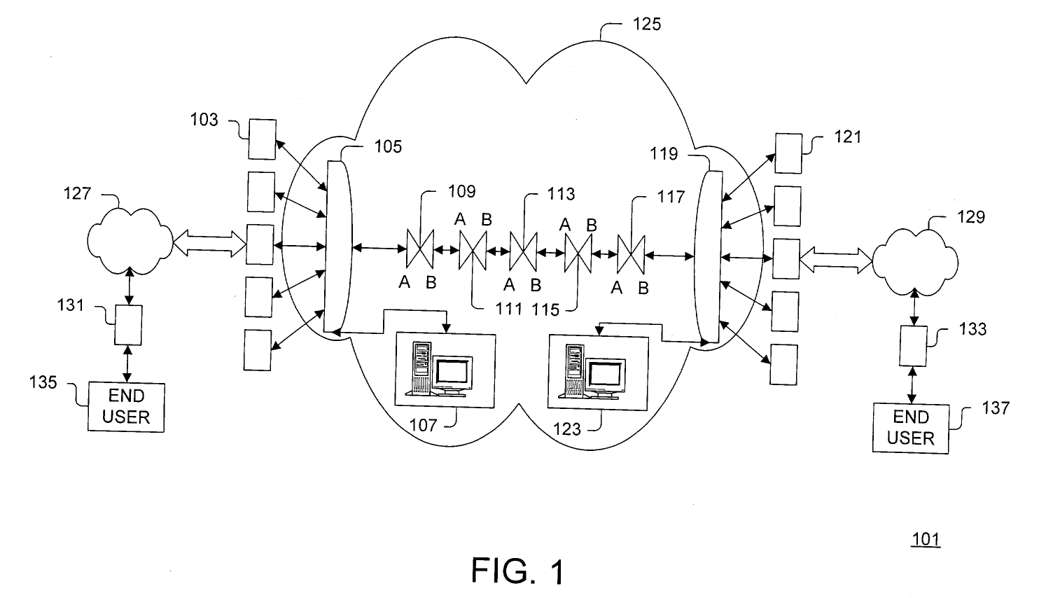

Referring now to the drawings, wherein like reference numerals designate identical or corresponding parts throughout the several views, and more particularly to FIG. 1 thereof, there is illustrated an exemplary optical transmission system 101 that can employ optical performance monitoring, according to an embodiment of the present invention. In FIG. 1, the system 101 includes, for example, optical networks 125, 127, and 129 for connecting end users 135 and 137 via respective optical network elements 131, 103, 121, and 133. The optical network elements 131, 103, 121, and 133 can include, for example, transponders, routers, switches, optical cross connects, add/drop multiplexers, etc. The optical networks 125, 127 and 129 can include, for example, a Dense Wavelength Division Multiplexing (DWDM) network, a Synchronous Optical NETwork (SONET), a Synchronous Digital Hierarchy (SDH) network, etc.

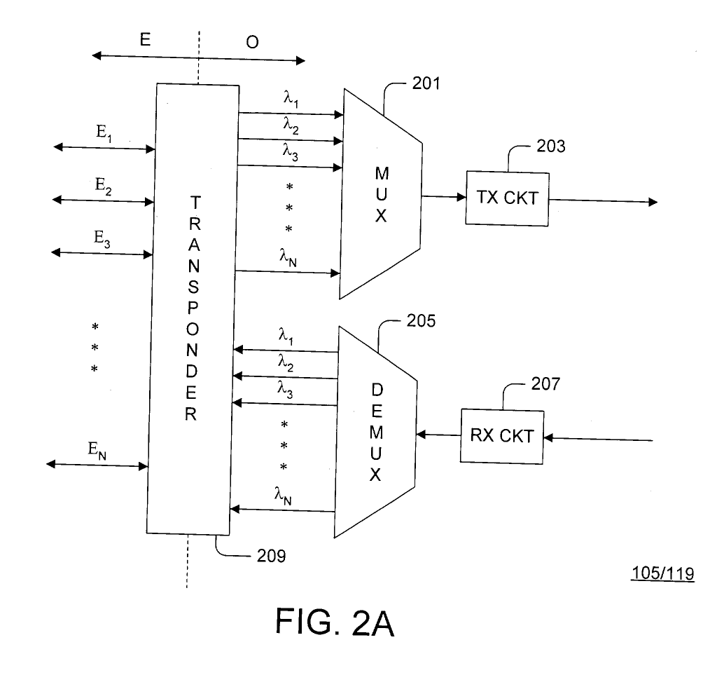

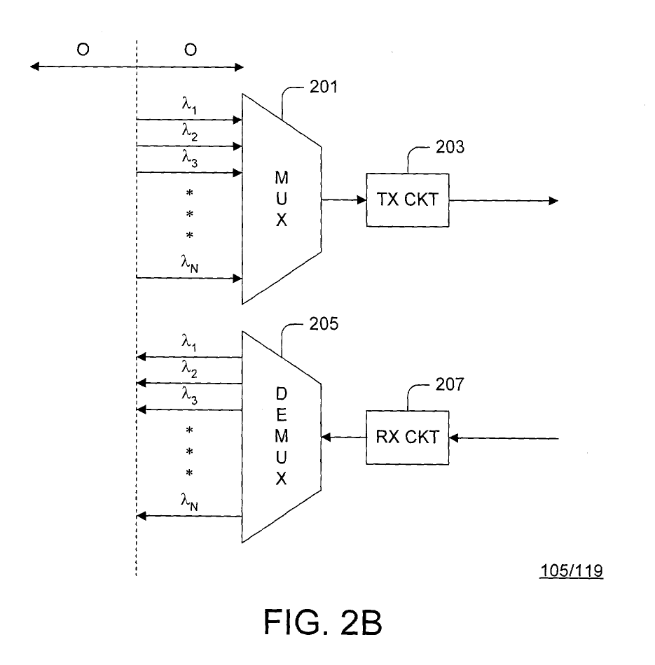

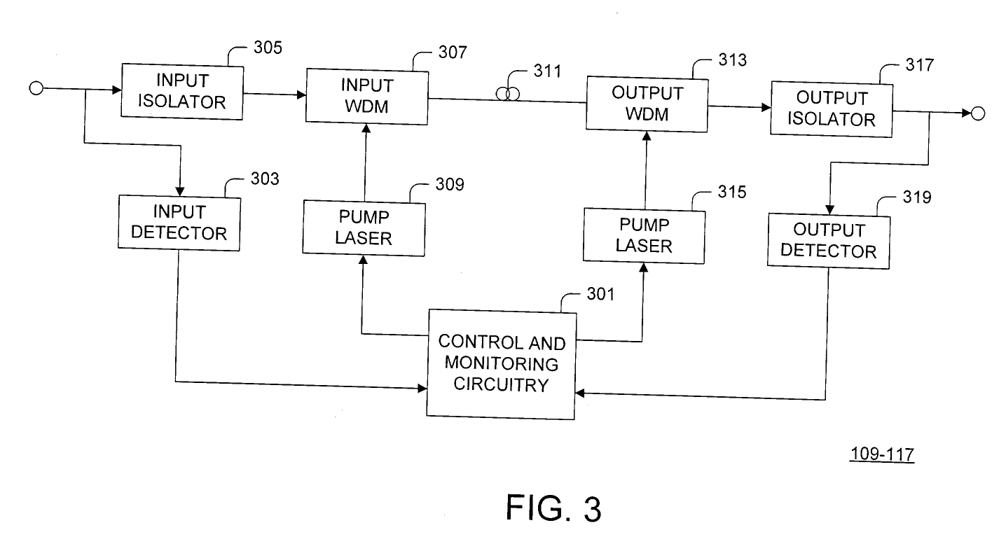

The optical networks 125, 127, and 129 include Network Management (NM) systems 107 and 123, DWDM devices 105 and 119 (e.g., manufactured by Nortel, MOR+, Siemens MTS, etc.), and optical amplifiers 109-117 (e.g., manufactured by Nortel, MOR+, Siemens MTS, etc.). The DWDM devices 105 and 119 can include, for example, optical-to-electrical-to-optical (o/e/o), all-optical (o/o/o) DWDM devices, etc., as further discussed with respect to FIGS. 2A and 2B. The optical amplifiers 109-117 can include, for example, semiconductor optical amplifiers (SOAs), Raman optical amplifiers, erbium doped fiber amplifiers (EDFAs), etc., as further discussed with respect to FIG. 3.

The system 101 of FIG. 1 can be employed in Long Haul (LH) and Ultra Long Haul (UHL) environments, for example, to connect the network elements 131 of one major metropolitan area to the network elements 103, 121, and 133 of other major metropolitan areas.

The system 101 performs an automated threshold setting process that determines and sets degradation intensity threshold values (Q₁, Q₂, . . . Qₙ) for each particular optical performance parameter (e.g., optical power (OP), optical signal-to-noise ratio (OSNR), wavelength drift, etc.) for each optical network element, such as the optical amplifiers 109-117. The value of each threshold can be dependent on the number of the optical network elements present within a given optical facility/circuit topology. In an exemplary embodiment, optical power thresholds of Q₃=0.1 dB, Q₂=0.5 dB, and Q₁=1.0 dB, optical signal-to-noise ratio thresholds of Q₃=20 dB, Q₂=15 dB, and Q₁=12 dB, and wavelength drift thresholds of Q₃=+/−1.25 GHz, Q₂=+/−3 GHz, and Q₁=+/−6.25 GHz can be employed.

Thus, the optical signal degradation is correspondingly greater from a less severe threshold (Q₃) crossing to a more sever threshold (Q₁) crossing. Advantageously, with the automated threshold setting process, the thresholds do not have to be manually set on a per optical network element basis. Due to the complexity in performing a manual threshold setting task, it is doubtful that it could be performed accurately and reliably, as compared to the automated threshold setting process.

The threshold setting process sets for each optical performance parameter a plurality of threshold values, with an intensity level and/or combination of intensity levels designed to determine a root cause of the electrical domain performance degradation. By contrast, if single threshold values for each parameter were used, the ability to automate trouble isolation would be limited due to the lack of information available on the extent of the optical degradation. In addition, if only one threshold value is employed, a user or system would have to query the optical network element to determine if the optical degradation has exceeded the threshold value and by how much. By using multiple threshold values, however, the extent of the degradation can be easily determined with the automated processes of the system 101.

The system 101 also performs an automated data collection process that checks, for example, via the Network Management systems 107 and/or 123, for electrical domain degradation at the electrical monitoring points, for example, at the DWDMs 105 and/or 119, and/or at the network elements 131, 103, 121, and/or 133. The electrical domain degradation can include, for example, Bit Error Rate (BER) degradation, etc. If electrical degradation is detected, for example, based on predetermined electrical performance objective thresholds, the data collection process determines whether there are optical network elements between the associated electrical monitoring points. If optical network elements between the associated electrical monitoring points are determined to exist, then, for each optical network element, optical performance data is collected for a finite period of time in receive and transmit directions, and is stored in associated registers and/or counters.

By using electrical degradation at the monitoring points as an initial starting point, advantageously, the optical performance monitoring can be blended with existing network management systems and procedures. By contrast, if electrical degradation at the monitoring points was not used, the amount of data that the network management systems would have to accommodate could easily double, resulting in a need to upgrade or replace such a system. Accordingly, by using the electrical degradation at the monitoring points as a starting point, the existing network management systems can continue to be used with minimal growth in a given platform.

The data collection process is further described in commonly-owned, commonly-assigned, U.S. patent application Ser. No. XX/XXX,XXX of Jayaram et al., entitled “SYSTEM AND METHOD FOR OPTICAL PERFORMANCE DATA COLLECTION,” (Attorney Docket No.: 09710-1160, MCI Docket No.: RIC-01-050) filed herewith, the entire contents of which is incorporated by reference herein.

The system 101 further performs an automated data analysis process that analyzes various intensity level optical performance threshold crossings for each optical network element in both the receive and the transmit directions. The data analysis process then correlates the receive and transmit direction performance data to determine which optical network elements, which optical fiber segments between optical network elements, and/or which optical performance parameter degradations may have contributed to the degradation in the electrical domain.

The data analysis process is further described in commonly-owned, commonly-assigned, U.S. patent application Ser. No. XX/XXX,XXX of Jayaram et al., entitled “SYSTEM AND METHOD FOR DETERMINING A CAUSE OF ELECTRICAL SIGNAL DEGRADATION BASED ON OPTICAL SIGNAL DEGRADTION,” (Attorney Docket No.: 09710-1161, MCI Docket No.: RIC-01-051) filed herewith, the entire contents of which is incorporated by reference herein.

The system 101, including the threshold setting, data collection, and data analysis processes, is further described in commonly-owned, commonly-assigned, U.S. patent application Ser. No. XX/XXX,XXX of Jayaram et al., entitled “METHOD AND SYSTEM FOR PERFORMANCE MONITORING IN AN OPTICAL NETWORK,” (Attorney Docket No.: 09710-1158, MCI Docket No.: COS-01-031) filed herewith, the entire contents of which is incorporated by reference herein.

The architecture of FIG. 1 is of an exemplary nature and the embodiments of the present invention are applicable to other optical networks and systems, such as non-DWDM networks and systems, etc., employing electrical and/or optical data, as will be appreciated by those skilled in the relevant art(s). The system 101 can include any suitable servers, workstations, personal computers (PCs), other devices, etc., such as the network management systems 107 and 123, capable of performing the processes of the present invention.

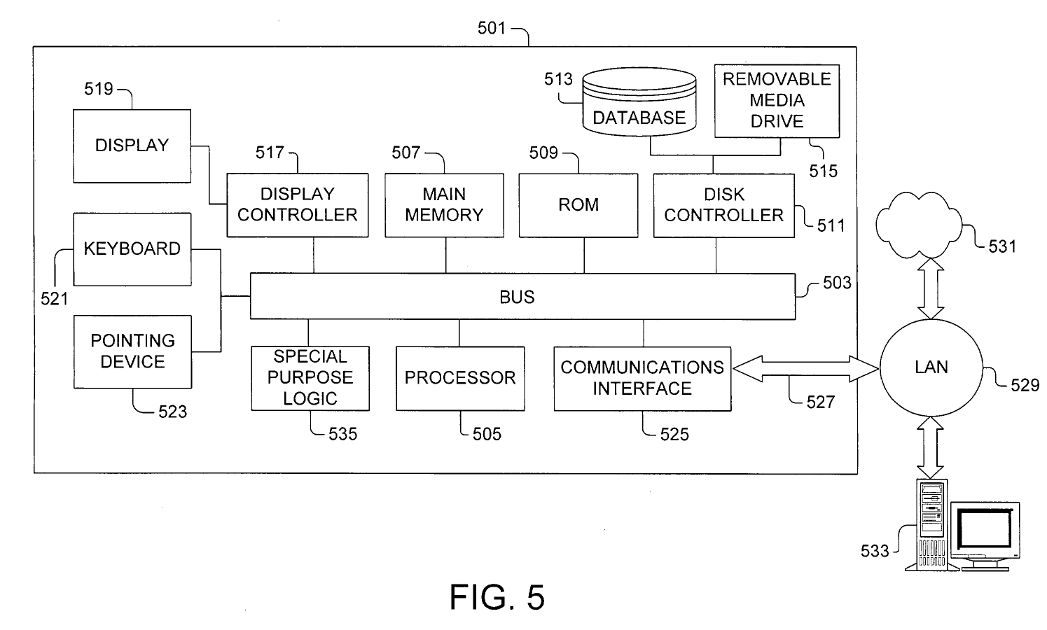

It is to be understood that the system in FIG. 1 is for exemplary purposes only, as many variations of the specific hardware and/or software used to implement the present invention are possible, as will be appreciated by those skilled in the relevant art(s). For example, the functionality of one or more of the devices of the system 101 can be implemented via one or more programmed computer systems or devices. To implement such variations as well as other variations, a single computer (e.g., the computer system 501 of FIG. 5) can be programmed to perform the special purpose functions of one or more of the devices of the system 101 of FIG. 1.

Alternatively, two or more programmed computer systems or devices, for example as in shown FIG. 5, may be substituted for any one of the devices of the system 101 of FIG. 1. Principles and advantages of distributed processing, such as redundancy, replication, etc., can also be implemented as desired to increase the robustness and performance of the system 101, for example.

FIG. 2A is a block diagram of the optical network components 105 and/or 119, for example, including DWDM devices, which can be employed as the electrical monitoring points for the system 101 of FIG. 1. In FIG. 2A, the DWDM devices include optical-to-electrical-to-optical (o/e/o) conversion, via a transponder 209. In the e/o direction, the transponder 209 converts electrical channel signals (E₁, E₂, E₃ . . . , E_{N}) received from optical network elements (e.g., the optical network elements 103 or 121) to optical channel signals (λ₁, λ₂, λ₃, . . . λ_{N}) for multiplexing via an optical multiplexer 201. The multiplexer 201 transmits the multiplexed optical channel signals to a transmit circuit 203 coupled to optical amplifiers (e.g., the optical amplifiers 109A or 117B) via an optical fiber. The transmit circuit 203 can include, for example, a laser, optical power amplifier, optical booster, etc.

In the o/e direction, the transponder 209 converts optical channel signals (λ₁, λ₂, λ₃, . . . λ_{N}) received from an optical demultiplexer 205 to electrical channel signals (E₁, E₂, E₃ . . . , E_{N}) for transmission to optical network elements (e.g., the optical network elements 103 or 121). The demultiplexer 205 receives multiplexed optical channel signals from a receive circuit 207 coupled to optical amplifiers (e.g., the optical amplifiers 109B or 117A) via an optical fiber. The receive circuit 207 can include, for example, an optical preamplifier, etc. The optical multiplexer 201 and the optical demultiplexer 205 can include, for example, optical filters, etc., to combine and separate the optical signal according to wavelength. The electrical channel signals (E₁, E₂, E₃ . . . , E_{N}) received from the DWDM 105 and DWDM 119 acting as the electrical monitoring points can be used by the network management systems 107 and/or 123 to perform the previously described threshold setting, data collection, and data analysis processes to determine the electrical domain degradation and find the root cause for the degradation in the optical domain.

FIG. 2B is a block diagram of the optical network components 105 and/or 119, for example, including all-optical (o/o/o) DWDM devices, which can be employed in the system 101 of FIG. 1, according to another embodiment. Under this scenario, the DWDM devices do not include optical-to-electrical-to-optical (o/e/o) conversion, and, hence, no transponder is employed. Accordingly, in this scenario, electrical channel signals can be received from the optical network elements 103 and 121 acting as the electrical monitoring points and including o/e/o conversion and used by the network management systems 107 and/or 123 to perform the previously described threshold setting, data collection, and data analysis processes to determine the electrical domain degradation and find the root cause for the degradation in the optical domain

In the o/o/ direction, optical network elements (e.g., the optical network elements 103 or 121) transmit optical channel signals (λ₁, λ₂, λ₃, . . . λ_{N}) to an optical multiplexer 201 for multiplexing. The multiplexer 201 transmits the multiplexed optical channel signals to a transmit circuit 203 coupled to optical amplifiers (e.g., the optical amplifiers 109A or 117B) via an optical fiber. In the /o/o direction, an optical demultiplexer 205 demultiplexes multiplexed optical channel signals received from a receive circuit 207 coupled to optical amplifiers (e.g., the optical amplifiers 109B or 117A) via an optical fiber. The optical demultiplexer 205 transmits the demultiplexed optical channel signals (λ₁, λ₂, λ₃, . . . λ_{N}) to optical network elements (e.g., the optical network elements 103 or 121).

FIG. 3 is a block diagram of an optical amplifier, which can be employed in the system of FIG. 1 (e.g., as the optical amplifiers 109-117). In FIG. 3, the optical amplifier is configured, for example, as an erbium doped fiber amplifier (EDFA) device. The optical amplifier includes control and monitoring circuitry 301 (e.g., microcontroller-based, microprocessor-based, digital signal processor-based, etc.) to monitor input light via an input detector 303 (e.g., light detector diode-based, etc.). The control and monitoring circuitry 301 can be used to provide optical performance information associated with the optical amplifier to the network management systems 107 and 123 over an optical service channel of a predetermined wavelength. An input isolator 305 can be employed and couples to an input WDM device 307 that provides a means of injecting a pumped wavelength (e.g., 980 nm) from a pump laser 309 into a length of erbium-doped fiber 311. The input WDM device 307 also allows the optical input signal (e.g., 1550 nm) to be coupled into the erbium-doped fiber 311 with minimal optical loss.

The erbium-doped optical fiber 313 can be tens of meters long. The pumped wavelength (e.g., 908 nm) energy pumps erbium atoms into a slowly decaying, excited state. When energy in a desired band (e.g., 1550 nm) travels through the fiber 311 it causes stimulated emission of radiation, much like in a laser, allowing the desired band signal to gain strength. The erbium fiber 311 has relatively high optical loss, so its length is optimized to provide maximum power output in the desired band. An output WDM device 313 is employed in dual pumped EDFAs, as shown in FIG. 3. The output WDM device 313 couples additional wavelength (e.g., 980 nm) energy from a pump laser 315 into the other end of the erbium-doped fiber 311, increasing gain and output power. An output isolator 317 can be employed coupled to an output detector 319 used to monitor the optical output power.

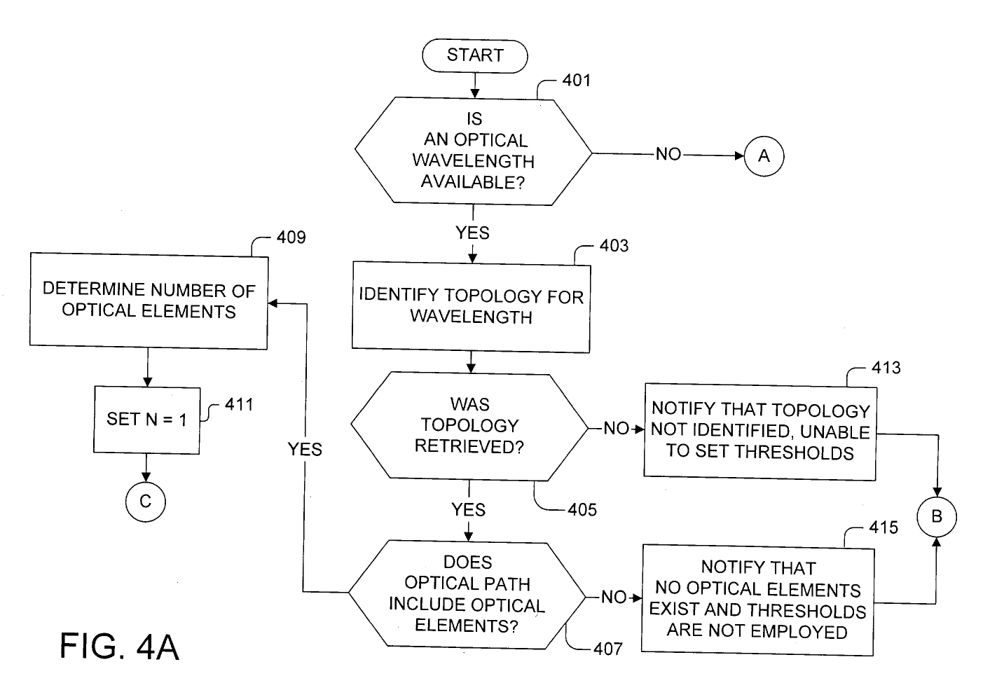

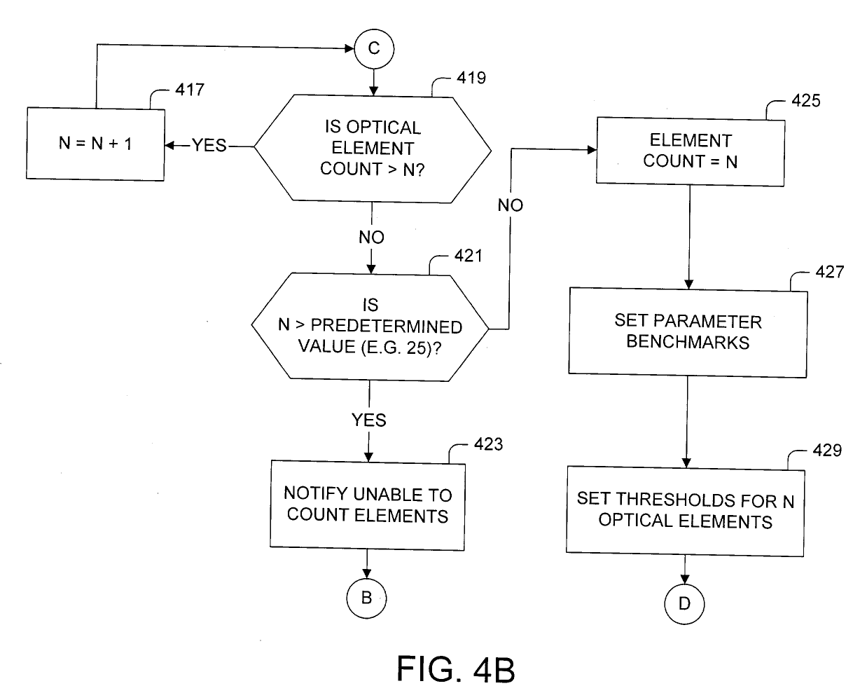

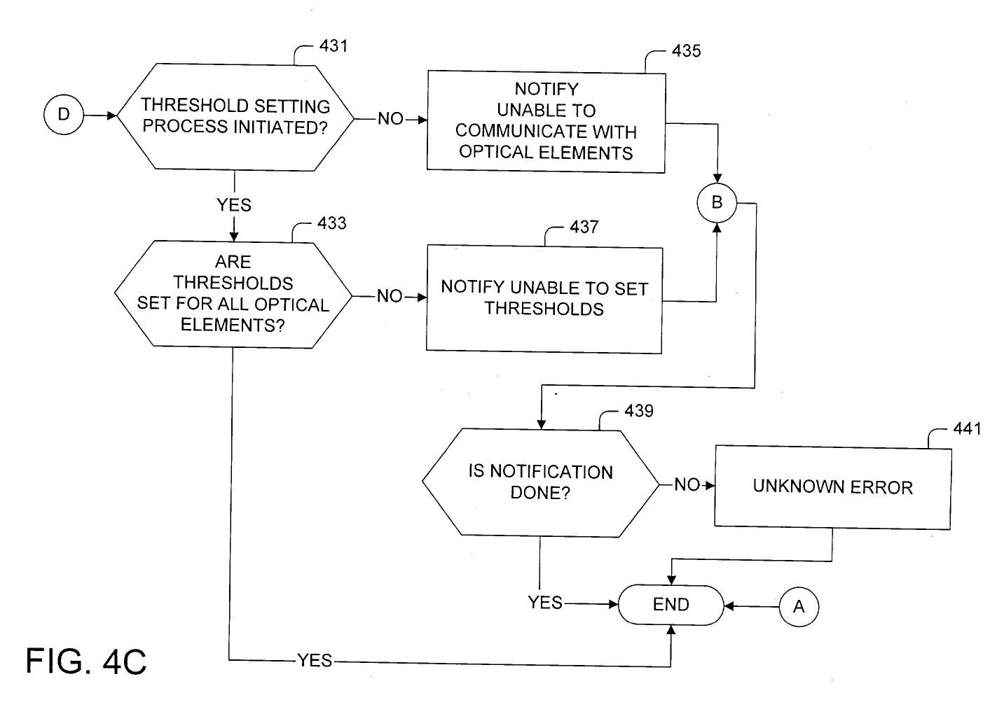

FIGS. 4A-4C are a flow chart of the previously described threshold setting process for setting thresholds for optical performance monitoring of the optical transmission system of FIG. 1, according to an embodiment of the present invention. In an exemplary embodiment, 1 to n thresholds are employed for each optical performance parameter Qₙ, where n=1 defines a first order of severity, n=2 defines a second order of severity, . . . , etc. Accordingly, each threshold Qₙ is set to a predetermined value Xₙ (e.g., Q₁=X₁, Q₂=X₂, . . . Qₙ=Xₙ). The optical performance parameters, Qₙ, define characteristics relating to the optical signal that affect signal quality and include, for example, optical power (OP), wavelength drift, optical signal-to-noise ratio (OSNR), etc.).

In FIGS. 4A-4C, at step 401, the process starts when activation of an optical signal is detected and an optical wavelength is available in the system 101. The threshold setting process is employed, for example, when an optical signal is activated or deactivated within a fiber. Examples of such optical signal include, for example, optical wavelengths, composite signals from a wave division multiplexing (WDM) system, and optical signals from other types of optical devices.

When the process determines that the optical signal has been activated and the optical wavelength is available, at step 403, the process then attempts to retrieve or identify, for example, via the network management systems 107 and/or 103, the topology information of the optical facility/circuit in question (e.g., the topology of the DWDM network 125). The topology information can include, for example, the optical (e.g., the optical amplifiers 109-117) and electrical (e.g., the DWDMs 105 and 119) network elements that make up the wavelength, physical locations of the network elements, the order in which the network elements are connected, the names assigned to the network elements and wavelengths used for communication purposes, the physical connections between the network elements, the electrical end points of the wavelength, etc.

If the topology infornation cannot be retrieved, as determined at step 405, the process notifies the system 101 (e.g., the network management systems 107 and/or 123) that the topology was not identified and that the thresholds values are unable to be set at step 413. The process, then, attempts to verify that the notification has been performed at step 439, and if the notification is verified, the process is completed. Otherwise, if the notification cannot be verified, an error is reported at step 441.

If, however, the topology can be retrieved, as determined at step 405, the process determines at step 407 if optical network elements are included in the optical path for the topology. If no optical network elements are determined to be included in the optical path, at step 415, the process notifies the system 101 that no optical network elements are included in the optical path, and that the thresholds are not employed. The process, then, attempts to verify that the notification has been performed at step 439, and if the notification is verified, the process is completed; otherwise, if the notification cannot be verified, an error is reported at step 441.

At step 409, the process determines the number (N) of optical network elements that are included in the optical path (e.g., the number of the optical amplifiers 109-117). The process then determines, at steps 411, 419, 417, 421, and 425, if the number of optical network elements is within an acceptable range (e.g., a positive integer, such as 25, etc., based on processing constraints of the system 101) for the threshold setting process. Otherwise, the process notifies the system 101 that the optical network elements cannot be counted at step 423. The process, then, attempts to verify that the notification has been performed at step 439, and if the notification is verified, the process is completed. Otherwise, if the notification cannot be verified, an error is reported at step 441.

If the process has determined that the optical network element count is within the acceptable range, at step 425, the process retrieves the current acceptable values for the optical parameters and sets the retrieved values as the benchmark values for each of the optical network elements. The benchmark values may include a delta value for each element, due to variables, such as distance between the optical network elements, fiber dispersion, connector loss, splice loss, fiber tilt, air gap, chromatic dispersion on the fiber facilities, etc. The benchmark values for each optical network element then are used to determine if an optical signal has changed or has degraded from a previous benchmark condition.

After the benchmarks are determined and set, at step 429, the process sets the threshold values for the N optical network elements (e.g., via a predetermined algorithm, etc.). The process employs the number of the optical network elements as a basis for determining the multiple threshold levels for each optical parameter (e.g., optical power, wavelength drift, OSNR, etc.). In an exemplary embodiment, the threshold levels (Q₁, Q₂, . . . Qₙ) are set to represent various severity levels (X₁, X₂, . . . Xₙ), wherein each threshold level indicates degradation which, depending on a number of degradations, can affect a level of service (e.g., quality of service (QoS), etc.) provided to end users by the optical transmission system 101. For example, a single Q₁ threshold crossing event may not indicate service disruptions, but multiple Q₁ threshold crossing events at multiple optical network elements contributes to the service degradation. Similarly, more severe degradations, such as indicated with Q₃ thresholds, can be set so that a single Q₃ threshold crossing signifies service degradation.

At step 431, the process determines whether the threshold setting has been initiated, and if so, at step 433 determines whether the thresholds have been set. If, however, the threshold setting is determined to not have been initiated, at step 435, the process notifies the system 101 that communication with the optical network elements was not initiated, and the process, then, attempts to verify that the notification has been performed at step 439. If the notification cannot be verified, an error is reported at step 441.

After the above process for setting thresholds for optical performance monitoring is performed, the previously described data collection process checks for electrical performance degradation at the electrical monitoring points, such as the DWDM devices 105 and/or 119 and/or the network elements 103 and/or 121. If electrical degradation is detected, the data collection process collects optical performance monitoring information from the optical network elements and interfaces associated with those optical network elements.

Once the optical performance information has been retrieved from the interfaces on the optical network elements, the optical performance information is passed to the previously described data analysis process for optical network element trouble isolation. The data analysis process uses the optical performance monitoring information collected from the optical network elements in a given path to perform the optical network element trouble isolation.

According to one embodiment, the system 101 stores information relating to various processes described herein. This information is stored in one or more memories, such as a hard disk, optical disk, magneto-optical disk, RAM, etc., for example, associated with the network management systems 107 and 123. One or more databases, such as databases within the devices of the system 101 of FIG. 1 can store the information used to implement the embodiments of the present invention. The databases are organized using data structures (e.g., records, tables, arrays, fields, graphs, trees, and/or lists) contained in one or more memories, such as the memories listed above or any of the storage devices listed below in the discussion of FIG. 5, for example.

The previously described processes include appropriate data structures for storing data collected and/or generated by the processes of the system 101 of FIG. 1 in one or more databases thereof. Such data structures accordingly can includes fields for storing such collected and/or generated data.

The embodiments of the present invention (e.g., as described with respect to FIGS. 1-4) can be implemented by the preparation of application-specific integrated circuits or by interconnecting an appropriate network of component circuits, as will be appreciated by those skilled in the electrical art(s). In addition, all or a portion of the invention (e.g., as described with respect to FIGS. 1-4) can be implemented using one or more general purpose computer systems, microprocessors, digital signal processors, micro-controllers, etc., programmed according to the teachings of the present invention (e.g., using the computer system 501 of FIG. 5), as will be appreciated by those skilled in the computer and software art(s). Appropriate software can be readily prepared by programmers of ordinary skill based on the teachings of the present disclosure, as will be appreciated by those skilled in the software art. Further, the embodiments of the present invention can be implemented on the World Wide Web (e.g., using the computer system 501 of FIG. 5).

FIG. 5 shows an exemplary computer system that can be programmed to perform one or more of the processes, in accordance with various embodiments of the present invention. The present invention can be implemented on a single such computer system, or a collection of multiple such computer systems. The computer system 501 includes a bus 503 or other communication mechanism for communicating information, and a processor 505 coupled to the bus 503 for processing the information. The computer system 501 also includes a main memory 507, such as a random access memory (RAM), other dynamic storage device (e.g., dynamic RAM (DRAM), static RAM (SRAM), synchronous DRAM (SDRAM)), etc., coupled to the bus 503 for storing information and instructions to be executed by the processor 505. In addition, the main memory 507 can also be used for storing temporary variables or other intermediate information during the execution of instructions by the processor 505. The computer system 501 further includes a read only memory (ROM) 509 or other static storage device (e.g., programmable ROM (PROM), erasable PROM (EPROM), electrically erasable PROM (EEPROM), etc.) coupled to the bus 503 for storing static information and instructions.

The computer system 501 also includes a disk controller 511 coupled to the bus 503 to control one or more storage devices for storing information and instructions, such as a magnetic hard disk 513, and a removable media drive 515 (e.g., floppy disk drive, read-only compact disc drive, read/write compact disc drive, compact disc jukebox, tape drive, and removable magneto-optical drive). Such storage devices can be added to the computer system 501 using an appropriate device interface (e.g., small computer system interface (SCSI), integrated device electronics (IDE), enhanced-IDE (E-IDE), direct memory access (DMA), or ultra-DMA).

The computer system 501 can also include special purpose logic devices 535, such as application specific integrated circuits (ASICs), full custom chips, configurable logic devices (e.g., simple programmable logic devices (SPLDs), complex programmable logic devices (CPLDs), field programmable gate arrays (FPGAs), etc.), etc., for performing special processing functions, such as signal processing, image processing, speech processing, voice recognition, infrared (IR) data communications, blanking circuit 208 functions, Rx circuit 204 functions, etc.

The computer system 501 can also include a display controller 517 coupled to the bus 503 to control a display 519, such as a cathode ray tube (CRT), liquid crystal display (LCD), active matrix display, plasma display, touch display, etc., for displaying or conveying information to a computer user. The computer system includes input devices, such as a keyboard 521 including alphanumeric and other keys and a pointing device 523, for interacting with a computer user and providing information to the processor 505. The pointing device 523, for example, can be a mouse, a trackball, a pointing stick, etc., or voice recognition processor, etc., for communicating direction information and command selections to the processor 505 and for controlling cursor movement on the display 519. In addition, a printer can provide printed listings of the data structures/information of the system shown in FIG. 1, or any other data stored and/or generated by the computer system 501.

The computer system 501 performs a portion or all of the processing steps of the invention in response to the processor 505 executing one or more sequences of one or more instructions contained in a memory, such as the main memory 507. Such instructions can be read into the main memory 507 from another computer readable medium, such as a hard disk 513 or a removable media drive 515. Execution of the arrangement of instructions contained in the main memory 507 causes the processor 505 to perform the process steps described herein. One or more processors in a multi-processing arrangement can also be employed to execute the sequences of instructions contained in main memory 507. In alternative embodiments, hard-wired circuitry can be used in place of or in combination with software instructions. Thus, embodiments are not limited to any specific combination of hardware circuitry and software.

Stored on any one or on a combination of computer readable media, the embodiments of the present invention include software for controlling the computer system 501, for driving a device or devices for implementing the invention, and for enabling the computer system 501 to interact with a human user (e.g., users of the system 101 of FIG. 1, etc.). Such software can include, but is not limited to, device drivers, operating systems, development tools, and applications software. Such computer readable media further includes the computer program product of the present invention for performing all or a portion (if processing is distributed) of the processing performed in implementing the invention. Computer code devices of the present invention can be any interpretable or executable code mechanism, including but not limited to scripts, interpretable programs, dynamic link libraries (DLLs), Java classes and applets, complete executable programs, Common Object Request Broker Architecture (CORBA) objects, etc. Moreover, parts of the processing of the present invention can be distributed for better performance, reliability, and/or cost.

The computer system 501 also includes a communication interface 525 coupled to the bus 503. The communication interface 525 provides a two-way data communication coupling to a network link 527 that is connected to, for example, a local area network (LAN) 529, or to another communications network 531 such as the Internet. For example, the communication interface 525 can be a digital subscriber line (DSL) card or modem, an integrated services digital network (ISDN) card, a cable modem, a telephone modem, etc., to provide a data communication connection to a corresponding type of telephone line. As another example, communication interface 525 can be a local area network (LAN) card (e.g., for Ethernet™, an Asynchronous Transfer Model (ATM) network, etc.), etc., to provide a data communication connection to a compatible LAN. Wireless links can also be implemented. In any such implementation, communication interface 525 sends and receives electrical, electromagnetic, or optical signals that carry digital data streams representing various types of information. Further, the communication interface 525 can include peripheral interface devices, such as a Universal Serial Bus (USB) interface, a PCMCIA (Personal Computer Memory Card International Association) interface, etc.

The network link 527 typically provides data communication through one or more networks to other data devices. For example, the network link 527 can provide a connection through local area network (LAN) 529 to a host computer 533, which has connectivity to a network 531 (e.g. a wide area network (WAN) or the global packet data communication network now commonly referred to as the “Internet”) or to data equipment operated by service provider. The local network 529 and network 531 both use electrical, electromagnetic, or optical signals to convey information and instructions. The signals through the various networks and the signals on network link 527 and through communication interface 525, which communicate digital data with computer system 501, are exemplary forms of carrier waves bearing the information and instructions.

The computer system 501 can send messages and receive data, including program code, through the network(s), network link 527, and communication interface 525. In the Internet example, a server (not shown) might transmit requested code belonging an application program for implementing an embodiment of the present invention through the network 531, LAN 529 and communication interface 525. The processor 505 can execute the transmitted code while being received and/or store the code in storage devices 513 or 515, or other non-volatile storage for later execution. In this manner, computer system 501 can obtain application code in the form of a carrier wave. With the system of FIG. 5, the present invention can be implemented on the Internet as a Web Server 501 performing one or more of the processes according to the present invention for one or more computers coupled to the Web server 501 through the network 531 coupled to the network link 527.

The term “computer readable medium” as used herein refers to any medium that participates in providing instructions to the processor 505 for execution. Such a medium can take many forms, including but not limited to, non-volatile media, volatile media, transmission media, etc. Non-volatile media include, for example, optical or magnetic disks, magneto-optical disks, etc., such as the hard disk 513 or the removable media drive 515. Volatile media include dynamic memory, etc., such as the main memory 507. Transmission media include coaxial cables, copper wire, fiber optics, including the wires that make up the bus 503. Transmission media can also take the form of acoustic, optical, or electromagnetic waves, such as those generated during radio frequency (RF) and infrared (IR) data communications. As stated above, the computer system 501 includes at least one computer readable medium or memory for holding instructions programmed according to the teachings of the invention and for containing data structures, tables, records, or other data described herein. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media can be involved in providing instructions to a processor for execution. For example, the instructions for carrying out at least part of the present invention can initially be borne on a magnetic disk of a remote computer connected to either of networks 529 and 531. In such a scenario, the remote computer loads the instructions into main memory and sends the instructions, for example, over a telephone line using a modem. A modem of a local computer system receives the data on the telephone line and uses an infrared transmitter to convert the data to an infrared signal and transmit the infrared signal to a portable computing device, such as a personal digital assistant (PDA), a laptop, an Internet appliance, etc. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

The embodiments described above, advantageously, perform data collection in a non-intrusive manner, and on an “as needed” basis. When performance degradation in the electrical domain is detected, the data collection mechanism is triggered to collect and report optical performance data associated with the electrical degradation. The concept of collection and storage of optical performance data on an “as needed” basis and in response to performance degradation in the electrical domain provides various advantages, as described herein.

The processes of the embodiments described above correlate performance activity in the electrical domain to performance degradation in the optical domain. Collecting and analyzing the optical domain degradation data when there is degradation activity in the electrical domain, advantageously, results in more efficient operation of a network management system and avoidance of unnecessary optical performance data collection.

The embodiments described above, advantageously, can be used in optical telecommunications networks, optical data networks, and/or any communications networks employing optical network elements, as will be appreciated by those skilled in the relevant art(s). The embodiments described above, advantageously, also can be used for keeping inventory of a number of optical network elements in an optical facility, keeping a record of optical performance parameter thresholds and data for an optical facility, long term performance trending based on the optical performance data, etc., as will be appreciated by those skilled in the relevant art(s).

The embodiments described above include recognition that, at present, there are no optical performance data threshold setting mechanisms that allow setting of multiple optical performance parameters with multiple thresholds and that a network management system can access and use to do analysis based on multiple threshold results. The embodiments described above determine optical performance parameter threshold settings based on optical network topology and/or a number of network elements in the topology.

The embodiments described above further provide optical performance monitoring mechanisms, which, advantageously, allow for automatic setting of multiple optical performance parameters with multiple thresholds, take into account differences in topology (e.g., the optical network elements that make up the wavelength, physical locations of the optical network elements, the names assigned to the optical network elements and wavelengths used for communication purposes, the physical connections between the optical network elements, the electrical end points of the wavelength, etc.), technology, etc., allow a Network Management system to identify and sectionalize a performance degradation problem, allow pinpointing a degree of severity of a performance degradation problem, allow for a higher quality of performance (e.g., quality of service (QoS), service level agreements (SLAs), service guarantee agreements (SGAs), etc.) to be set in an optical network than is possible using manual methods, allow for automating of tasks that would otherwise be manually performed, allow for reduced operating costs (e.g., by using less o/e/o devices, etc.) and problem resolution time in an optical system, etc.

While the present invention has been described in connection with a number of embodiments and implementations, the present invention is not so limited, but rather covers various modifications and equivalent arrangements, which fall within the purview of the appended claims.

What is claimed is:

1. A method of monitoring an optical transmission system, the method comprising:
assigning a plurality of threshold values corresponding to a performance parameter associated with the optical transmission system; and
identifying degradation of the optical transmission system based on which of the threshold values being exceeded.

2. The method of claim 1, further comprising:
determining a quantity of optical network elements within the optical transmission system; and
setting the threshold values for each of the optical network elements based on the determined quantity.

3. The method of claim 1, wherein the threshold values correspondingly represent degrees of intensity of degradation relating to performance of the optical transmission system.

4. The method of claim 2, further comprising:
determining a topology of the optical transmission system in response to a detected optical signal; and
indicating an error if the topology cannot be determined.

5. The method of claim 1, further comprising:
determining a benchmark value for the performance parameter based on a current value of the performance parameter.

6. The method of claim 1, wherein the performance parameter includes at least one of optical power, optical signal-to-noise ratio, and wavelength drift.

7. An optical network management system, comprising:
means for assigning a plurality of threshold values corresponding to a performance parameter associated with an optical transmission system; and
means for identifying degradation of the optical transmission system based on which of the threshold values being exceeded.

8. The system of claim 7, further comprising:
means for determining a quantity of optical network elements within the optical transmission system; and
means for setting the threshold values for each of the optical network elements based on the determined quantity.

9. The system of claim 7, wherein the threshold values correspondingly represent degrees of intensity of degradation relating to performance of the optical transmission system.

10. The system of claim 8, further comprising:
means for determining a topology of the optical transmission system in response to a detected optical signal; and
means for indicating an error if the topology cannot be determined.

11. The system of claim 7, further comprising:
means for determining a benchmark value for the performance parameter based on a current value of the performance parameter.

12. The system of claim 7, wherein the performance parameter includes at least one of optical power, optical signal-to-noise ratio, and wavelength drift.

13. A computer-readable medium carrying one or more sequences of one or more instructions for monitoring an optical transmission system, the one or more sequences of one or more instructions include instructions which, when executed by one or more processors, cause the one or more processors to perform the steps of:
assigning a plurality of threshold values corresponding to a performance parameter associated with the optical transmission system; and
identifying degradation of the optical transmission system based on which of the threshold values being exceeded.

14. The computer-readable medium of claim 13, wherein the one or more processors further perform the steps of:
determining a quantity of optical network elements within the optical transmission system; and
setting the threshold values for each of the optical network elements based on the determined quantity.

15. The computer-readable medium of claim 13, wherein the threshold values correspondingly represent degrees of intensity of degradation relating to performance of the optical transmission system.

16. The computer-readable medium of claim 14, wherein the one or more processors further perform the steps of:
determining a topology of the optical transmission system in response to a detected optical signal; and
indicating an error if the topology cannot be determined.

17. The computer-readable medium of claim 13, wherein the one or more processors further perform the step of:
determining a benchmark value for the performance parameter based on a current value of the performance parameter.

18. The computer-readable medium of claim 13, wherein the performance parameter includes at least one of optical power, optical signal-to-noise ratio, and wavelength drift.
